(19) United States
(12) Patent Application Publication
(10) Pub. No.: US 2014/0317018 A1
(43) Pub. Date: Oct. 23, 2014

(54) System and Method for Managing Investments with an Investment Model

(71) Applicant: Mid Atlantic Capital Group, Pittsburgh, PA (US)

(72) Inventor: Paul Schneider, Naperville, IL (US)

(73) Assignee: Mid Atlantic Capital Group, Pittsburgh, PA (US)

(21) Appl. No.: 14/209,140

(22) Filed: Mar. 13, 2014

Related U.S. Application Data
(60) Provisional application No. 61/778,900, filed on Mar. 13, 2013.

(51) Int. Cl. G06Q 40/06

(52) U.S. Cl. CPC G06Q 40/06
USPC 705/36 R

(57) ABSTRACT

A computer-implemented method for managing a plurality of 401(k) accounts comprises the step of transmitting data configured to generate at least one graphical user interface comprising selectable options configured to facilitate a user to create an investment model for the plurality of 401(k) accounts, wherein the created investment model comprises a plurality of securities and, for each security of the plurality of securities, a target percentage. The method further includes the step of automatically initiating investments at predetermined intervals for each 401(k) account of the plurality of 401(k) accounts based at least partially on the investment model, wherein each investment is based at least partially on the target percentage of a corresponding security, such that an allocation of assets for each 401(k) account of the plurality of 401(k) accounts is rebalanced according to the target percentage for each security. A system for performing the method is also disclosed.

### CROSS REFERENCE TO RELATED APPLICATION

This application claims priority to U.S. Provisional Patent Application No. 61/778,900, filed Mar. 13, 2013, entitled “System and Method for 401(k) Investment Management”, the entire disclosure of which is herein incorporated by reference.

### BACKGROUND OF THE INVENTION

1. Field of the Invention

The present invention relates to investment management and, in particular, to computer-implemented systems and methods for managing investments with investment models.

2. Description of Related Art

Financial managers, including record keepers, advisors and third party managers who offer models using exchange traded funds (ETFs) and mutual funds must often rebalance calculations and trades. Further, such financial managers are limited in that the funds used in the models must be offered as participant directed elections.

Further, financial managers that specialize in 401(k) management are unable to seamlessly incorporate investment models into a retirement plan, and are often required to use multiple services and systems to create, execute, and manage investment models.

Traditionally, the process of coordinating all of the moving parts required for Plan Record Keepers to effectively manage an investment model within a retirement plan has been a tedious process. Each time the advisor calls to submit a change to the investment model, it results in a stream of trades and record adjustments in order to keep the plan in compliance.

Section 408(b)(2) of the Employee Retirement Income Security Act of 1974 (ERISA) requires disclosures of product category, product benchmark, product performance data, and product strategies and risk. Section 404(a)(5) requires disclosures to participants or beneficiaries. These disclosure requirements are complicated and difficult to manage with multiple client accounts.

### SUMMARY OF THE INVENTION

According to a preferred and non-limiting embodiment of the present invention, provided is a computer-implemented method for managing a plurality of 401(k) accounts, comprising: transmitting, to a user computer, data configured to generate at least one graphical user interface comprising selectable options configured to facilitate a user to create an investment model for the plurality of 401(k) accounts, wherein the created investment model comprises a plurality of securities and, for each security of the plurality of securities, a target percentage; receiving, from the user computer, data representing the created investment model; storing the data representing the investment model in at least one data storage unit; automatically initiating investments, with at least one processor, at a predetermined intervals for each 401(k) account of the plurality of 401(k) accounts based at least partially on the investment model, wherein each investment is based at least partially on the target percentage of a corresponding security, such that an allocation of assets for each 401(k) account of the plurality of 401(k) accounts is rebalanced according to the target percentage for each security; receiving, from the user computer, modifications to the investment model resulting a modified investment model; automatically initiating investments for each 401(k) account, with at least one processor, based at least partially on the modified investment model; generating, with at least one processor, at least one report based at least partially on the investments; making the created investment model available via a collective investment fund structure external to the plurality of 401(k) accounts.

According to a further preferred and non-limiting embodiment of the present invention, provided is a system for managing a plurality of 401(k) accounts, comprising: (a) a management interface comprising selectable options configured to facilitate a manager to create an investment model, wherein the created investment model comprises a plurality of securities and, for each security of the plurality of securities, a target percentage; (b) a model database storing a plurality of investment models created through the management interface; and (c) at least one server computer comprising at least one processor, the at least one server computer configured to: automatically initiate a plurality of trades for a plurality of client 401(k) accounts based on the created investment model, wherein a value of each trade of the plurality of trades is determined based on the target percentage for a corresponding security of the plurality of securities and a current asset allocation of each client 401(k) account of the plurality of client 401(k) accounts; generate at least one report based at least partially on data calculated based at least partially on attributes of the plurality of client 401(k) accounts; provide access to the created investment model for a retail account outside of the plurality of client 401(k) accounts or through a collective fund structure.

According to another preferred and non-limiting embodiment of the present invention, provided is a computer program product for managing a plurality of 401(k) accounts, comprising at least one non-transitory computer-readable medium including program instructions that, when executed by at least one processor of at least one computer, cause the at least one computer to: transmit, to a financial manager computer, data configured to generate at least one graphical user interface comprising selectable options configured to facilitate a financial manager to create an investment model for the plurality of 401(k) accounts, wherein the created investment model comprises a plurality of securities and, for each security of the plurality of securities, a target percentage; store the data representing the investment model in at least one data structure; automatically rebalance each client 401(k) account of the plurality of 401(k) accounts based on the created investment model by initiating trades of at least one security of the plurality of securities based on the target percentage of the at least one security and a current allocation of assets across the plurality of securities for each client 401(k) account of the plurality of 401(k); provide access to the created investment model to other entities, such that the created investment model can be used to rebalance a retail plan outside of the plurality of 401(k) accounts; modify the created investment model based at least partially on input received from the financial manager, resulting in a modified investment model; automatically rebalance each client 401(k) account of the plurality of 401(k) accounts based at least partially on the modified investment model; and generate a report for at least one client 401(k) account based at least partially on predefined criteria

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic diagram for a system and method for managing 401(k) accounts according to the principles of the present invention;

FIG. 2 is a graphical user interface (GUI) for a system and method for managing 401(k) accounts according to the principles of the present invention;

FIG. 3 is a model detail and automated processing option GUI for a system and method for managing 401(k) accounts according to the principles of the present invention;

FIG. 4 is a model investment target GUI for a system and method for managing 401(k) accounts according to the principles of the present invention;

FIG. 5 is a sample factsheet GUI for a system and method for managing 401(k) accounts according to the principles of the present invention;

FIG. 6 is a performance data GUI for a system and method for managing 401(k) accounts according to the principles of the present invention;

FIG. 7 is an investment model dashboard GUI for a system and method for managing 401(k) accounts according to the principles of the present invention;

FIG. 8 is a 401(k) investor chart;

FIG. 9 is a 401(k) market share chart;

FIG. 10 is two 401(k) asset allocation charts for different aged participants; and

FIG. 11 is a schematic diagram of a computer environment according to the prior art.

### DESCRIPTION OF THE INVENTION

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

In a preferred and non-limiting embodiment of the present invention, provided is a 401(k) management system that allows financial management professionals to seamlessly incorporate investment models into a 401(k) retirement plan through a single system including one or more web-based interfaces. In some non-limiting embodiments, a single web-based interface may be used.

In a preferred and non-limiting embodiment of the present invention, a graphical user interface (GUI) is provided to a user that includes various tools, selection options, and/or interactive data that allows for a user to create a custom 401(k) investment model for ETFs and/or mutual fund investments. It will be appreciated that other investment vehicles and financial products may also be used to create the custom 401(k) investment model.

Once a custom 401(k) investment model is created, the model is stored in a model database and can be modified by the user that created it or, in some examples, other parties. The system automatically initiates investments in a number of client 401(k) accounts based on the custom investment model. Subsequent modifications to the custom investment model result in the automatic synchronization of associated client 401(k) accounts, not requiring the user to log into multiple separate record keeping systems every time a change is made. Further, combining the automatic synchronization features with unitizing various securities and generating reports for government-mandated disclosure requirements, allows for a scalable and effective 401(k) management system.

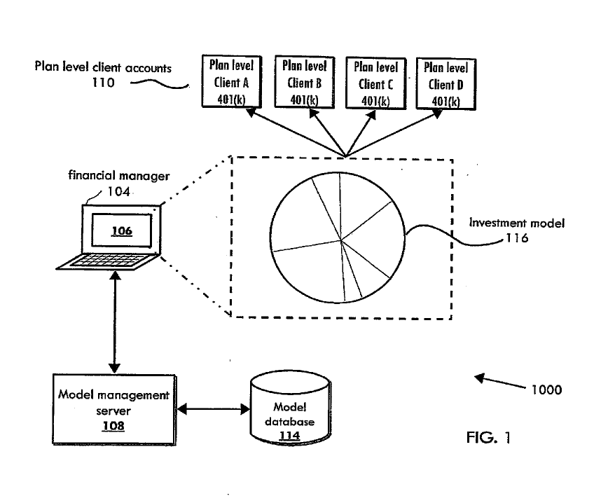

Referring now to FIG. 1, a system 1000 for managing 401(k) accounts is shown according to a preferred and non-limiting embodiment. A model management server 108 is in communication with a model database 114 and a computer 104 of a financial manager. The financial manager's computer 104 may communicate with the model management server 108 through the internet, such as over an HTTP connection. The financial manager's computer 104 generates a GUI 106 based on data communicated from the model management server 108. The GUI allows for the creation and/or modification of one or more investment models 116, which represent an allocation of funds by percentage in various investments such as, but not limited to, ETFs and/or mutual funds.

With continued reference to FIG. 1, the investment model 116 serves as a global allocation model for the client 401(k) accounts 110. Thus, modifications made to various allocations and/or aspects of the investment model 116 will result in modifications made to all corresponding 401(k) accounts (i.e., Plan Level Client A, Plan Level Client B, Plan Level Client C, Plan Level Client D) without having to log into multiple systems and manage individual accounts. This functionality lends itself to the creation of a pooled investment vehicle that, by being pooled at the participant or plan level, does not intermingle client funds, or more precisely, Plan Level Client A does not mix their assets with Client B, Client C, Client D, and so on.

In one preferred and non-limiting embodiment, users can set security and cash targets, as well as specific investment exclusions requested by a fiduciary of the 401(k) plan. All of the plan flows, asset levels, and detailed information relating to the 401(k) plan are provided to users through one or more GUIs including, but not limited to, an easy to navigate website. The management fee associated with the 401(k) plan may be accrued daily and automatically paid at predetermined intervals (e.g., monthly or quarterly).

For Plan Investment Advisors, access to a stable of third party money managers with proven track records that are able to provide models comprised of ETFs and/or mutual funds designed for a 401(k) plan may provide many advantages. Thus, the system 1000 is capable of providing investment advisors with the best money managers available, and simplifies the due diligence screening process by providing manager profiles, descriptions, performance data, and/or other like data for each investment model 116. This reduces the amount of time required to review the myriad of data in order to make an effective choice for a client. Additionally, Plan Investment Advisors are assured that their client's plan is synchronized with a manager's recommendations.

In addition to synchronizing an investment model 116 with individual 401(k) accounts 110, including automatically processing specific investment exclusions, the system 1000, in one preferred and non-limiting embodiment, also provides reporting metrics and various tools for advisors to utilize in order to fulfill their fiduciary responsibilities. Disclosure requirements under Sections 408(b)(2) and 404(a)(5) may be satisfied with automatic calculations of fees, values, and other variables to generate necessary reports and disclosures. The reports and disclosures may be automatically transmitted to remote server computers and/or submitted according to predefined guidelines. For example, in non-limiting embodiments, a report may be generated based on U.S. Department of Labor fee disclosure requirements of ERISA 404a-5 and 408b-2 (participant fee disclosure). In some non-limiting embodiments, e-signature functionality and automated document tracking may be provided.

In a preferred and non-limiting embodiment of the invention, an investment model created through the system 1000 may be made available to retail accounts outside of a client 401(k) account. Further, a Bank Collective Fund may be formed off of the same investment model such that any 401(k) plan outside the network of the system 1000 can have access to the model via a Collective Investment Fund (CIF) structure having a pooled group of trust accounts. Accordingly, the plan does not have to be in the custody of the provider of the system 1000 in order to access the investment model that is created through the system 1000. The investment model can be purchased through such a collective structure when a custodian of the plan is a member of the National Securities Clearing Corporation (NSCC) or other like entity. In such embodiments, the manager that creates and modifies the investment model through the system 1000 can manage a single model and apply it to various different types of plans. For example, a CIF may have an NSCC-eligible Committee on Uniform Securities Identification Procedures number (CUSIP) and can be traded directly by any 401(k) similar to buying a mutual fund, and all daily inflows and outflows are managed automatically by the system 1000. A single model may therefore be applied to multiple client plans of different types, 401(k) accounts 110, retail accounts, and through the CIF, without running afoul of creating a de facto mutual fund and while being compliant with the Securities and Exchange Commission Rule 3A-4.

In non-limiting embodiments, the system 1000 provides various benefits to Third Party Administrators (TPAs) and record keepers. For example, each managed plan or model only requires a single security identifier, similar to a CUSIP for a registered security, for setting up the plan or model and initiating trades, whereas prior to system 1000, the individual CUSIPS comprising the model had to individually be set up in the record keeper's system. Calculations and trades do not have to be rebalanced after every modification to the plan or model, and the limitation that funds used in models be offered as participant directed elections may be eliminated. Further, if the managing user subscribes to a public/full service option, there may be no responsibility for calculations and factsheets for disclosure requirements on behalf of the TPA and/or record keeper, advisor or manager.

In non-limiting embodiments, the system 1000 provides various benefits to manager users. For example, managers can trade and make fund changes at the model level across plans and TPAs, and for retail accounts. Automated rebalancing of trades can be scheduled for regular intervals. In some examples, there may be no trading limits. Further, the management fee may be automatically accrued and paid, and management fees may be customized per plan if desired by the manager user, without having to code said management fee on each record keeping system as was the case prior to system 1000. Managers may also customize management fees per plan, and track flows and fees by plan, by TPA, by mode, or by advisor. The system 1000 may be configured to handle and process all performance reporting, fact sheets, and disclosure data points. Further, managers may also benefit from the elimination of the limitation that funds used in models must be offered as participant directed options.

In non-limiting embodiments, the system 1000 provides an automatic liquidity management feature. Through a GUI, a manager is able to specify a liquidity range and a liquidity target. The liquidity range represents a range of liquidity for an account, and the liquidity target represents an optimal liquidity. These criteria may be specified and modified for each individual client account, or across multiple accounts. Thus, trades in the accounts may be automatically initiated whenever the liquidity of the accounts is outside the specified liquidity range. In embodiments, the value of these trades, in the aggregate, may approximate the difference between current liquidity of the accounts and the liquidity target. The investment model(s) may influence the securities being traded under this liquidity feature, such that the securities chosen for trading are aligned with a specified investment model.

In a preferred and non-limiting embodiment, a unitization process is used in combination with the automatic synchronization of client 401(k) accounts with the specified investment model. Unitization, also referred to Unit Value Accounting, is used to calculate a dollar value of funds in the client 401(k) accounts. By unitizing securities, participants may effectively buy or sell shares of a security without fully entering the market and therefore avoiding lengthy processing delays, brokerage fees, and the like. Thus, client sales and purchases within a fund are offset.

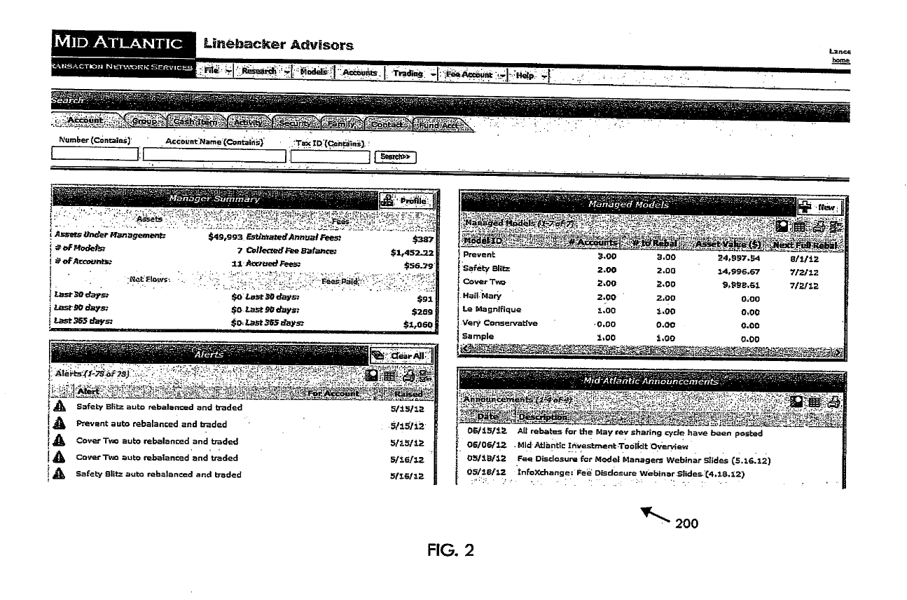

Referring now to FIG. 2, shown is a management GUI 200 according to a preferred and non-limiting embodiment of the present invention. The management GUI 200 includes a variety of frames and/or windows including, for example, a manager summary window, a managed models window, an alerts window, and an announcement window. The managed models windows shows various investment models listed by an identifier, a number of client 401(k) accounts corresponding to each investment model, a number of client 401(k) accounts to be automatically rebalanced according to changes in the investment model, an asset value for each investment model, and a scheduled date for a next rebalancing of the client 401(k) accounts for each investment model.

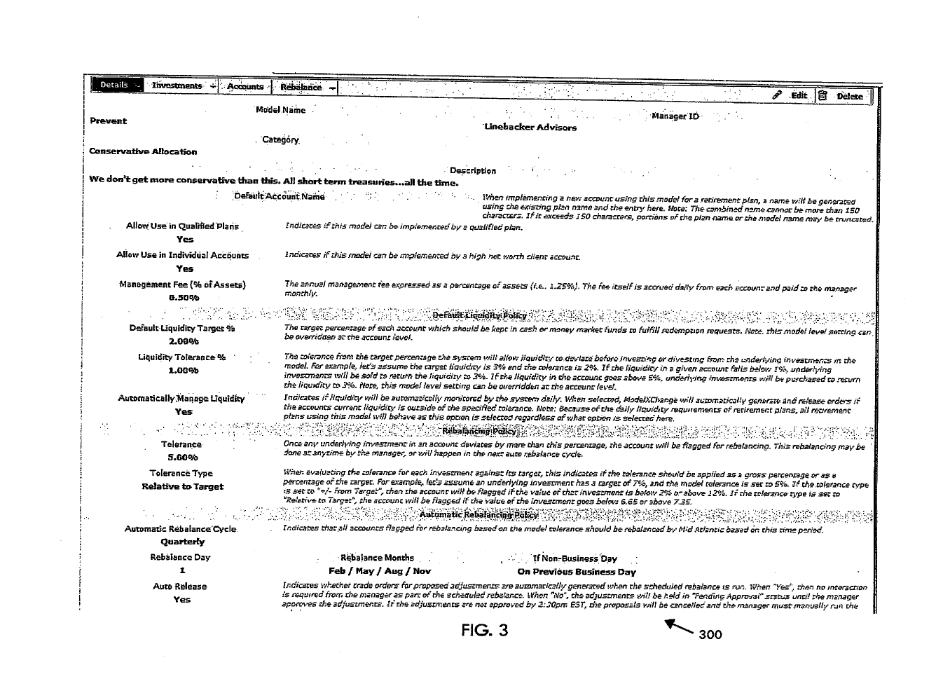

Referring now to FIG. 3, shown is a model detail and automated processing option GUI 300 according to a preferred and non-limiting embodiment. The GUI 300 shows various details of an investment model including the management fee, default liquidity target percentage, liquidity tolerance percentage, an indication of whether the model automatically manages liquidity, a rebalancing tolerance percentage, a rebalancing tolerance type, an automatic rebalancing cycle or time interval, and other factors and details. Next to each investment detail, a short description is provided describing the particular feature or attribute of the model.

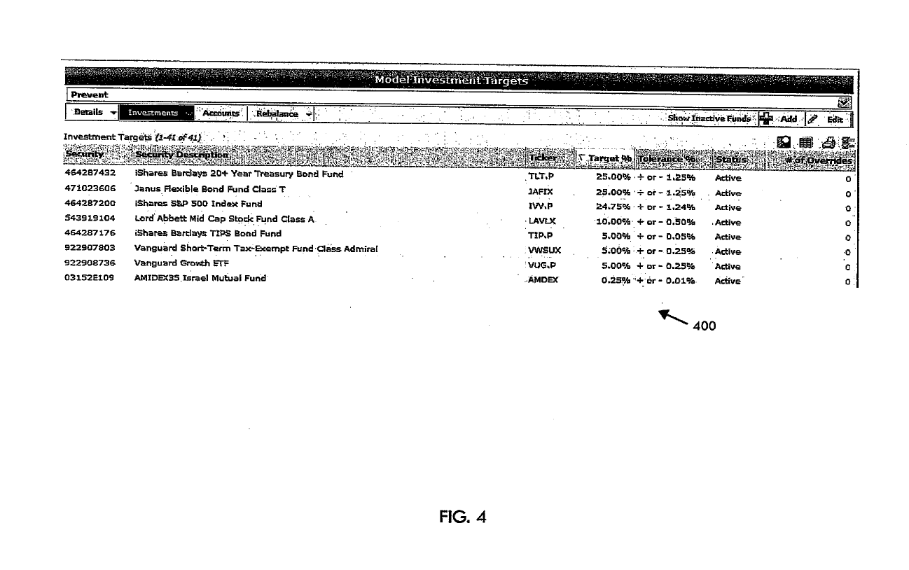

Referring now to FIG. 4, shown is a model investment target GUI 400 according to a preferred and non-limiting embodiment. The GUI 400 lists various securities, including ETFs and mutual funds, along with corresponding ticker symbols, target percentages, tolerance percentages, statuses, and number of overrides. The target percentage indicates the allocation of funds to a particular security. As can be seen in FIG. 4, the iShares Barclays Treasury Bond Fund, the Janus Flexible Bond Fund, and the iShares S&P 500 Index Fund constitute almost three-quarters of total asset allocation in this particular investment model.

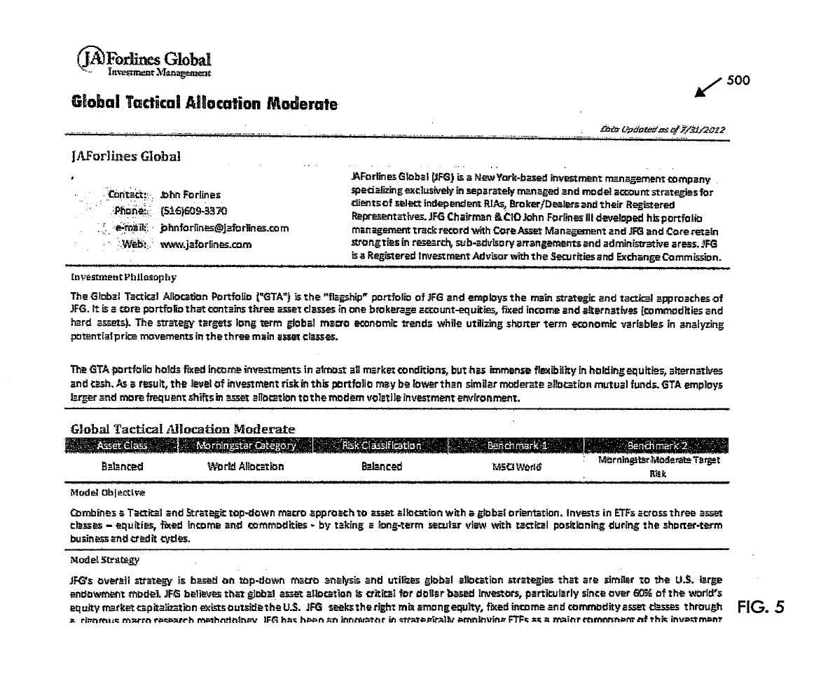

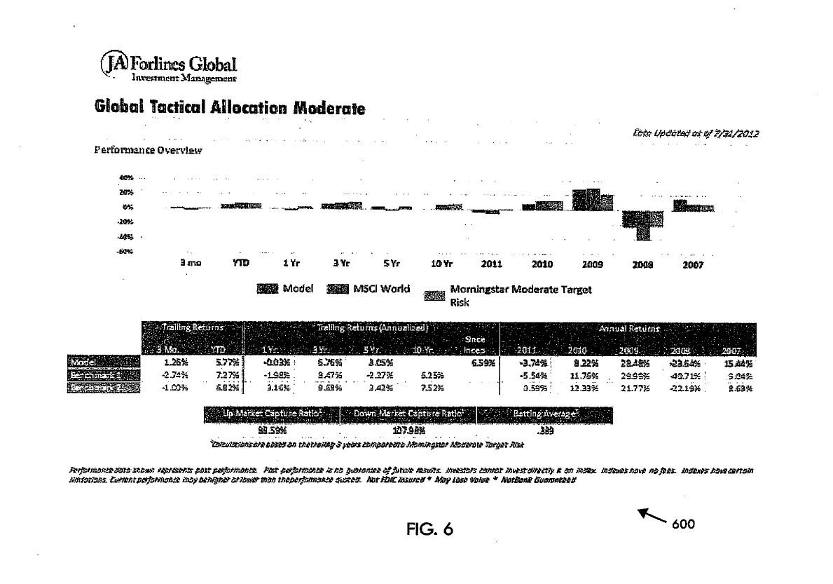

FIG. 5 shows a sample factsheet GUI 500 according to a preferred and non-limiting embodiment. FIG. 6 shows a performance data GUI 600 according to a preferred and non-limiting embodiment. As can be seen, performance data may be presented in the GUI 600 in various tables, charts, graphs, and/or the like. The performance data GUI 600 allows for the comparison of investment models with benchmarks.

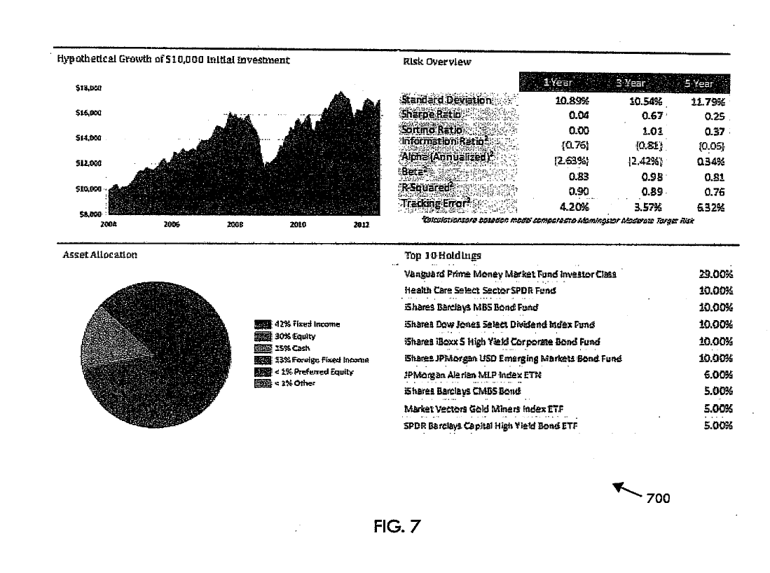

FIG. 7 shows a dashboard GUI 700 according to a preferred and non-limiting embodiment. The dashboard GUI 700 includes various visualizations of asset allocations, holdings by percentage, risk overviews, and hypothetical growth for a certain amount of initial investment. It will be appreciated that data relating to the investment models and/or individual 401(k) accounts may be visualized with any number of tables, charts, and/or graphs.

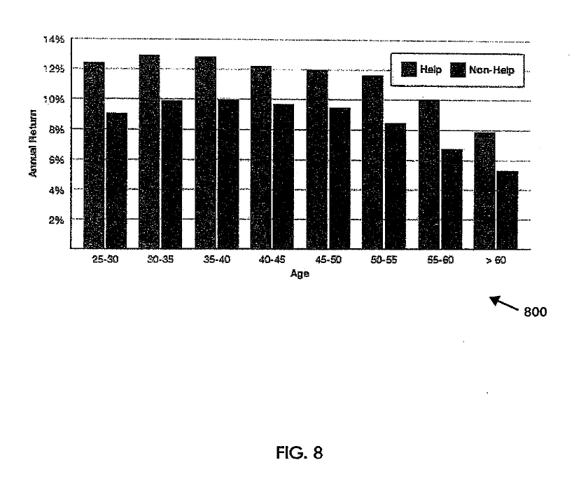

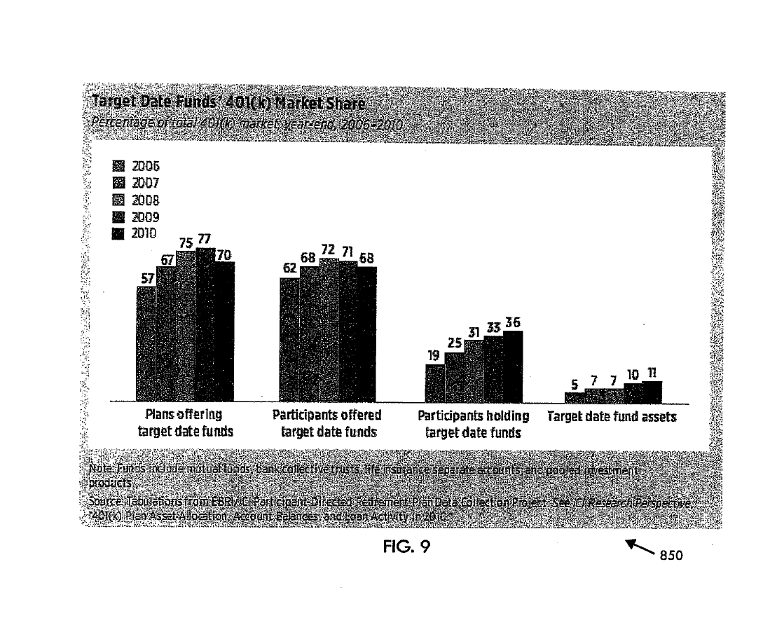

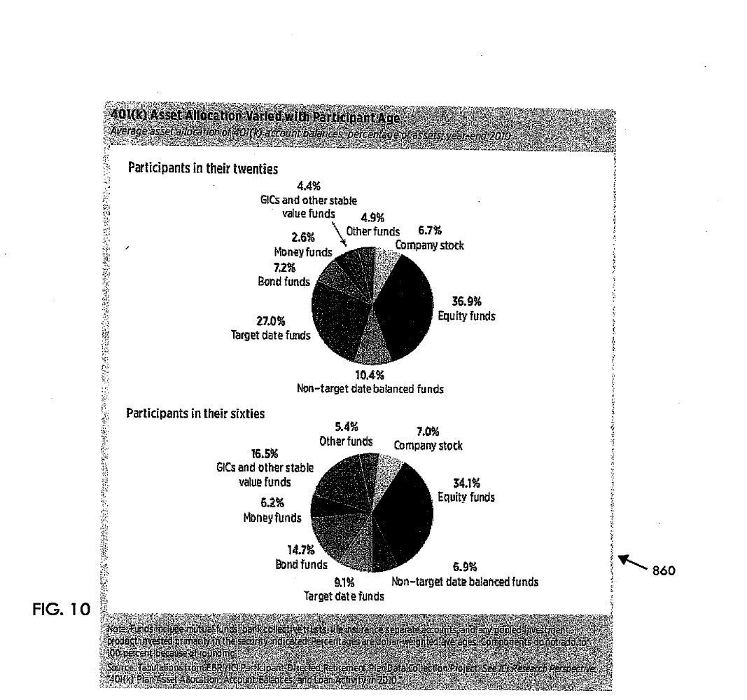

FIGS. 8-10 show various charts 800, 850, 860 relating to 401(k) investments and, in particular, investment data for 401(k) accounts. FIG. 8 shows a 401(k) investor chart 800, FIG. 9 shows a 401(k) market share chart 850, and FIG. 10 shows two 401(k) asset allocation charts 860 for different aged participants.

Appendix A of U.S. Provisional Patent Application No. 61/778,900, which is hereby incorporated by reference, is a master services agreement, including corresponding exhibits, that define one non-limiting set of policies that may govern use of the system 1000. However, it will be appreciated that numerous arrangements, agreements, policies, and/or protocols may be used. Referring to Exhibit B of Appendix A of U.S. Provisional Patent Application No. 61/778,900, a table is shown for ERISA disclosure data elements that indicates what data elements a model manager is responsible for providing, and what data elements that the system 1000 generates. The data elements indicated to be provided by the system 1000 may be automatically generated based on data relating to the investment models, individual 401(k) accounts, manager preferences, government regulations, and/or the like.

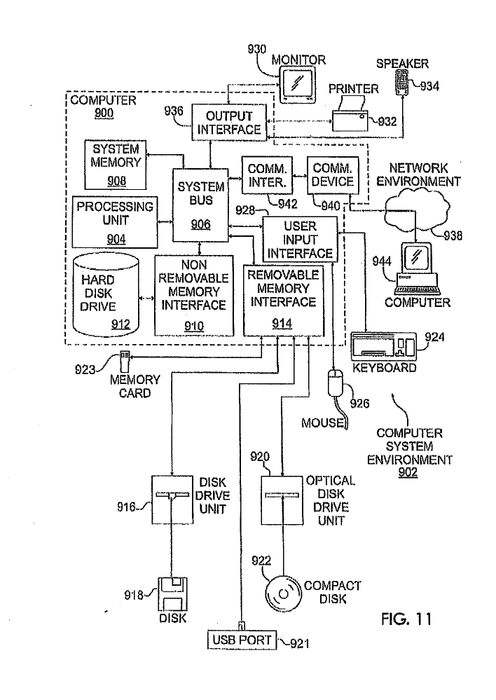

The present invention may be implemented on a variety of computing devices and systems, wherein these computing devices include the appropriate processing mechanisms and computer-readable media for storing and executing computer-readable instructions, such as programming instructions, code, and the like. As shown in FIG. 11, personal computers 900, 944, in a computing system environment 902 are provided. This computing system environment 902 may include, but is not limited to, at least one computer 900 having certain components for appropriate operation, execution of code, and creation and communication of data. For example, the computer 900 includes a processing unit 904 (typically referred to as a central processing unit or CPU) that serves to execute computer-based instructions received in the appropriate data form and format. Further, this processing unit 904 may be in the form of multiple processors executing code in series, in parallel, or in any other manner for appropriate implementation of the computer-based instructions.

In order to facilitate appropriate data communication and processing information between the various components of the computer 900, a system bus 906 is utilized. The system bus 906 may be any of several types of bus structures, including a memory bus or memory controller, a peripheral bus, or a local bus using any of a variety of bus architectures. In particular, the system bus 906 facilitates data and information communication between the various components (whether internal or external to the computer 900) through a variety of interfaces, as discussed hereinafter.

The computer 900 may include a variety of discrete computer-readable media components. For example, this computer-readable media may include any media that can be accessed by the computer 900, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 900. Further, this computer-readable media may include communications media, such as computer-readable instructions, data structures, program modules, or other data in a modulated data signal, such as a carrier wave or other transport mechanism and include any information delivery media, wired media (such as a wired network and a direct-wired connection), and wireless media (such as acoustic signals, radio frequency signals, optical signals, infrared signals, biometric signals, bar code signals, etc.). Of course, combinations of any of the above should also be included within the scope of computer-readable media.

The computer 900 further includes a system memory 908 with computer storage media in the form of volatile and non-volatile memory, such as ROM and RAM. A basic input/output system (BIOS) with appropriate computer-based routines assists in transferring information between components within the computer 900 and is normally stored in ROM. The RAM portion of the system memory 908 typically contains data and program modules that are immediately accessible to or presently being operated on by processing unit 904, e.g., an operating system, application programming interfaces, application programs, program modules, program data and other instruction-based computer-readable codes.

With continued reference to FIG. 11, the computer 900 may also include other removable or non-removable, volatile or non-volatile computer storage media products. For example, the computer 900 may include a non-removable memory interface 910 that communicates with and controls a hard disk drive 912, i.e., a non-removable, non-volatile magnetic medium; and a removable, non-volatile memory interface 914 that communicates with and controls a magnetic disk drive unit 916 (which reads from and writes to a removable, non-volatile magnetic disk 918), an optical disk drive unit 920 (which reads from and writes to a removable, non-volatile optical disk 922, such as a CD ROM), a Universal Serial Bus (USB) port 921 for use in connection with a removable memory card, etc. However, it is envisioned that other removable or non-removable, volatile or non-volatile computer storage media can be used in the exemplary computing system environment 900, including, but not limited to, magnetic tape cassettes, DVDs, digital video tape, solid state RAM, solid state ROM, etc. These various removable or non-removable, volatile or non-volatile magnetic media are in communication with the processing unit 904 and other components of the computer 900 via the system bus 906. The drives and their associated computer storage media discussed above and illustrated in FIG. 11 provide storage of operating systems, computer-readable instructions, application programs, data structures, program modules, program data and other instruction-based computer-readable code for the computer 900 (whether duplicative or not of this information and data in the system memory 908).

A user may enter commands, information, and data into the computer 900 through certain attachable or operable input devices, such as a keyboard 924, a mouse 926, etc., via a user input interface 928. Of course, a variety of such input devices may be utilized, e.g., a microphone, a trackball, a joystick, a touchpad, a touch-screen, a scanner, etc., including any arrangement that facilitates the input of data, and information to the computer 900 from an outside source. As discussed, these and other input devices are often connected to the processing unit 904 through the user input interface 928 coupled to the system bus 906, but may be connected by other interface and bus structures, such as a parallel port, game port, or a universal serial bus (USB). Still further, data and information can be presented or provided to a user in an intelligible form or format through certain output devices, such as a monitor 930 (to visually display this information and data in electronic form), a printer 932 (to physically display this information and data in print form), a speaker 934 (to audibly present this information and data in audible form), etc. All of these devices are in communication with the computer 900 through an output interface 936 coupled to the system bus 906. It is envisioned that any such peripheral output devices be used to provide information and data to the user.

The computer 900 may operate in a network environment 938 through the use of a communications device 940, which is integral to the computer or remote therefrom. This communications device 940 is operable by and in communication to the other components of the computer 900 through a communications interface 942. Using such an arrangement, the computer 900 may connect with or otherwise communicate with one or more remote computers, such as a remote computer 944, which may be a personal computer, a server, a router, a network personal computer, a peer device, or other common network nodes, and typically includes many or all of the components described above in connection with the computer 900. Using appropriate communication devices 940, e.g., a modem, a network interface or adapter, etc., the computer 900 may operate within and communication through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 900, 944 may be used.

As used herein, the computer 900 includes or is operable to execute appropriate custom-designed or conventional software to perform and implement the processing steps of the method and system of the present invention, thereby, forming a specialized and particular computing system. Accordingly, the presently-invented method and system may include one or more computers 900 or similar computing devices having a computer-readable storage medium capable of storing computer-readable program code or instructions that cause the processing unit 902 to execute, configure or otherwise implement the methods, processes, and transformational data manipulations discussed hereinafter in connection with the present invention. Still further, the computer 900 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

It will be apparent to one skilled in the relevant art(s) that the system may utilize databases physically located on one or more computers which may or may not be the same as their respective servers. For example, programming software on computer 900 can control a database physically stored on a separate processor of the network or otherwise.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for managing a plurality of 401(k) accounts, comprising:
transmitting, to a user computer, data configured to generate at least one graphical user interface comprising selectable options configured to facilitate a user to create an investment model for the plurality of 401(k) accounts, wherein the created investment model comprises a plurality of securities and, for each security of the plurality of securities, a target percentage;
receiving, from the user computer, data representing the created investment model;
storing the data representing the investment model in at least one data storage unit;
automatically initiating investments, with at least one processor, at a predetermined interval for each 401(k) account of the plurality of 401(k) accounts based at least partially on the investment model, wherein each investment is based at least partially on the target percentage of a corresponding security, such that an allocation of assets for each 401(k) account of the plurality of 401(k) accounts is rebalanced according to the target percentage for each security;
receiving, from the user computer, modifications to the investment model resulting in a modified investment model;
automatically initiating investments for each 401(k) account, with at least one processor, based at least partially on the modified investment model;
generating, with at least one processor, at least one report based at least partially on the investments; and
making the created investment model available via a collective investment fund structure external to the plurality of 401(k) accounts.

2. The method of claim 1, wherein the plurality of securities comprise at least one of an exchange traded fund and a mutual fund.

3. The method of claim 1, further comprising transmitting, to a user computer, data configured to generate at least one graphical user interface configured ₜo display a plurality of investment models created by managers, wherein each investment model of the plurality of investment models is associated with at least one of the following: a manager profile, a model description, performance data, or any combination thereof.

4. The method of claim 3, further comprising receiving, from the user computer, a selected investment model from the plurality of investment models, wherein the plurality of investment models comprises the created investment model, and wherein the selected investment model is the created investment model.

5. The method of claim 1, wherein the created investment model further comprises a liquidity range and a liquidity target value, the method further comprising:
determining, for at least one client 401(k) account of the plurality of 401(k) accounts, a liquidity value; and
automatically initiating investments for a client 401(k) account when the liquidity value is outside of the liquidity range, such that the investments adjust the liquidity value to a value that is inside of the liquidity range.

6. The method of claim 5, wherein the liquidity range and the liquidity target value is at least one of the following: specific for each client 401(k) account of the plurality of 401(k) accounts, or specific for the created investment model and applicable to all client 401(k) accounts of the plurality of 401(k) accounts.

7. The method of claim 5, wherein an aggregate value of the investments initiated automatically when the liquidity value is outside of the liquidity range is an approximate difference between a current liquidity of the client 401(k) account and the liquidity target.

8. The method of claim 1, wherein the created investment model comprises, for each security of the plurality of securities, a tolerance percentage, wherein each investment is based at least partially on the tolerance percentage of a corresponding security.

9. The method of claim 1, wherein the user interface comprises a managed models window, the managed models window comprising a plurality of investment models and a number of client 401(k) accounts corresponding to each investment model of the plurality of investment models.

10. The method of claim 1, wherein the user interface comprises a model detail and automated processing option interface comprising, for the created investment model, a management fee associated with the created investment model, a liquidity target percentage, an indication of whether the created investment model automatically manages liquidity, a rebalancing tolerance percentage, and an automatic rebalancing cycle or time interval.

11. The method of claim 1, further comprising automatically calculating fees and values for a client 401(k) account based on predefined guidelines, wherein the at least one report generated comprises the calculated fees and values.

12. A system for managing a plurality of 401(k) accounts, comprising:
(a) a management interface comprising selectable options configured to facilitate a manager to create an investment model, wherein the created investment model comprises a plurality of securities and, for each security of the plurality of securities, a target percentage;
(b) a model database storing a plurality of investment models created through the management interface; and
(c) at least one server computer comprising at least one processor, the at least one server computer configured to:
(i) automatically initiate a plurality of trades for a plurality of client 401(k) accounts based on the created investment model, wherein a value of each trade of the plurality of trades is determined based on the target percentage for a corresponding security of the plurality of securities and a current asset allocation of each client 401(k) account of the plurality of client 401(k) accounts;
(ii) generate at least one report based at least partially on data calculated based at least partially on attributes of the plurality of client 401(k) accounts; and
(iii) provide access to the created investment model for a retail account outside of the plurality of client 401(k) accounts or through a collective fund structure.

13. The system of claim 12, wherein the at least one server computer is further configured to:
receive modifications to the created investment model resulting in a modified investment model; and
automatically initiate a plurality of trades for the plurality of client 401(k) accounts based at least partially on the modified investment model.

14. The system of claim 12, wherein the plurality of trades are automatically initiated at a predetermined time interval, such that an allocation of assets for each client 401(k) account of the plurality of client 401(k) accounts is rebalanced according to the target percentage for each security.

15. The system of claim 12, wherein the management interface further comprises selectable options configured to facilitate the manager to specify a liquidity range and a liquidity target value for at least one of an individual client 401(k) account or the plurality of client 401(k) accounts.

16. The system of claim 15, wherein the at least one server computer is further configured to:
determine, for at least one client 401(k) account of the plurality of client 401(k) accounts, a current liquidity value;
compare the current liquidity value to at least one of the liquidity range and the target liquidity; and
automatically initiate a plurality of trades for the at least one client 401(k) account when the current liquidity value is outside of the liquidity range, such that the plurality of trades adjust the liquidity value to a value that is inside of the liquidity range.

17. The system of claim 12, further comprising a user interface configured to display a plurality of investment models created by a plurality of managers, the plurality of investment models comprising the created investment model, wherein each investment model of the plurality of investment models is associated with at least one of the following: a manager profile, a model description, performance data, or any combination thereof.

18. The system of claim 17, wherein each investment model of the plurality of investment models is assigned a single security identifier.

19. A computer program product for managing a plurality of 401(k) accounts, comprising at least one non-transitory computer-readable medium including program instructions that, when executed by at least one processor of at least one computer, cause the at least one computer to:
transmit, to a financial manager computer, data configured to generate at least one graphical user interface comprising selectable options configured to facilitate a financial manager to create an investment model for the plurality of 401(k) accounts, wherein the created investment model comprises a plurality of securities and, for each security of the plurality of securities, a target percentage;
store the data representing the investment model in at least one data structure;
automatically rebalance each client 401(k) account of the plurality of 401(k) accounts based on the created investment model by initiating trades of at least one security of the plurality of securities based on the target percentage of the at least one security and a current allocation of assets across the plurality of securities for each client 401(k) account of the plurality of 401(k);
provide access to the created investment model to other entities, such that the created investment model can be used to rebalance a retail plan outside of the plurality of 401(k) accounts;
modify the created investment model based at least partially on input received from the financial manager, resulting in a modified investment model; and
automatically rebalance each client 401(k) account of the plurality of 401(k) accounts based at least partially on the modified investment model.

20. The computer program product of claim 19, wherein the program instructions, when executed, further cause the at least one computer to generate a report for at least one client 401(k) account based at least partially on predefined criteria.
